(19) United States
(12) Patent Application Publication
(10) Pub. No.: US 2010/0260527 A1
(43) Pub. Date: Oct. 14, 2010

(54) PRINT LINE MANAGEMENT FOR CUT SHEET PRINTERS

(75) Inventors: Marc W. Webster, Rochester, NY (US); Dragana Pavlovic, Rochester, NY (US); Michael P. Kirby, Pittsford, NY (US); Amy M. Zaremski, Fairport, NY (US); Neil Dempsey, Victor, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: XEROX CORPORATION, Norwalk, CT (US)

(21) Appl. No.: 12/420,878

(22) Filed: Apr. 9, 2009

(51) Int. Cl. G03G 15/00; B65H 31/00

(52) U.S. Cl. 399/397; 271/207

(57) ABSTRACT

Multi-colorant and monochromatic digital image print lines are connected to operate sequentially from a single sheet feeder in a first mode and switchable to operate independently from separate feeders in a second mode. The print lines may include sets of monochromatic and multi-colorant marking engines.

### BACKGROUND

The present disclosure relates to digital image printing on print lines designed to handle cut sheet print media and particularly to such print lines where it is desired to have high speed capability for duplex printing and the capability to print both monochrome and multi-colorant images on the sheet stock. Heretofore, where high speed duplex printing capability was desired, print lines were connected in dedicated tandem to permit concurrent printing on opposite sides of the sheets in the separate print lines, thereby doubling the number of sheets per minute as compared with duplex printing on a single print line by inverting and re-feeding. Where a user required high speed duplex printing capability yet wished to also have high speed simplex capability, the tandem print line arrangement required one print line to remain dormant and permit the sheets printed on the other print line to pass there through without printing or to by-pass the remaining print line thus reducing the capability of the arrangement. Thus, the user's investment is substantially increased for the sake of having high speed duplex printing capability.

Furthermore, in the event that one print line is disabled, the entire system is off-line despite the healthy state of the remaining print line.

In addition, where a user required high volume monochrome printing, as for example the pages of a book, and addition of a color insert or color image cover for the book, it was required to print the color image or insert on a separate multi-colorant print line and physically transport the color image sheets to the finisher of the monochrome print line for final document or book assembly. In the normal context, a sheet stock print line includes a feeder, a marking engine and a finisher arranged in a single cabinet or juxtaposed individual cabinets.

Heretofore, where a user required duplex printing of the type where a color image was marked on one side of the sheet and a monochrome image on the opposite side, the equipment arrangement required a monochrome print line in tandem with a multi-colorant print line. However, where a substantial percentage of the print jobs involved monochrome printing, the multi-colorant print line remained idle and thus became an investment burden for a limited functional need. although it is possible to print the monochrome print job on the color print line as a composite black marking of the multi-colorant marking engine, such a use is costly in the use of the multi-colorant ink for the sake of increased monochrome printing speed.

It has thus been desired to provide a way or means of enabling a user to perform high-speed digital printing on cut sheet media with both monochrome and color capability with minimum investment in equipment. It has also been desired to provide the capability of digital cut sheet printing in duplex mode and at relatively high speeds combined with multi-colorant image printing and at minimal equipment cost.

### BRIEF DESCRIPTION

The present disclosure provides for controlling multiple print lines for digital printing on cut sheet media employing juxtaposed print engines which may be controlled to operate in one mode for independently printing different print jobs and also may be operated in a tandem mode whereupon sheets marked in one engine are fed directly to another marking engine. The engines may be either all monochromatic or may include both monochromatic and multi-colorant marking capabilities. The control arrangement enables duplex printing in either monochromatic or hybrid mode whereupon a monochromatic image is printed on one side of a sheet and a color image on the opposite side; and, the print lines in the tandem mode provide for duplex printing at twice the speed of a single print line due to the concurrent marking in two print lines.

In other versions, a pair of print lines may be operated in tandem in juxtaposition with an additional print engine which may be operated independently whereupon the tandem engines may comprise the combination of a monochrome and multi-colorant engine with the remaining print line dedicated to monochromatic printing.

Other versions include a pair of tandem marking engines juxtaposed with a second pair thus permitting concurrent printing in each pair of print lines where the pairs are operated in series or tandem feeding sheets from only one feeder; and, alternatively the print lines may be operated independently. The user may select the desired mode or functions from a graphical user interface supplied with each of the print lines. The graphical user interfaces are interconnected with the machine controllers such that all modes or functions may be accessed from any of the graphical user interfaces.

### BRIEF DESCRIPTION OF THE DRAWINGS

FIG. 1 is a pictorial representation of a monochromatic print line juxtaposed with a second print line;

FIG. 2 is a pictorial representation of a monochromatic and a multi-colorant print line juxtaposed with a common finisher;

FIG. 3 is a block diagram representation of the architecture of the print line arrangement of FIG. 1;

FIG. 4 is a block diagram of an alternative arrangement of the architecture of FIG. 3;

FIG. 5 is pictorial representation of three single print lines juxtaposed;

FIG. 6 is a pictorial representation of two print lines arranged in two tandem pairs each having a pair of tandem marking engines;

FIG. 7 is a pictorial representation of four single print lines juxtaposed in tandem;

FIG. 8 is a pictorial representation of a pair of monochromatic print lines juxtaposed with a multi-colorant print line; and,

FIG. 9 is a pictorial representation of a print line with an interposed auxiliary feeder and off-line finisher.

### DETAILED DESCRIPTION

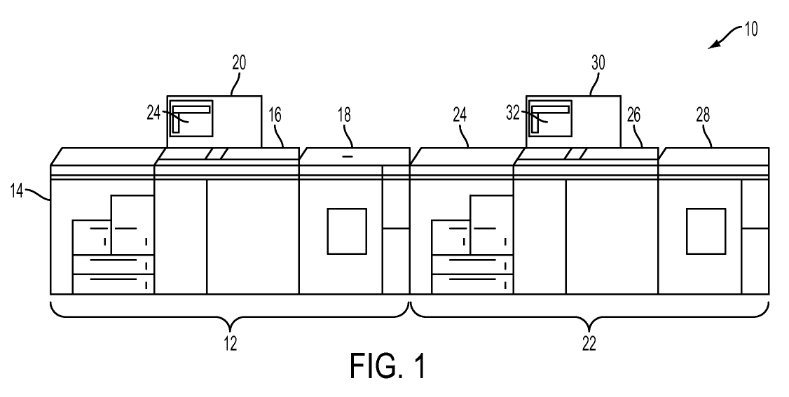

Referring to FIG. 1, a digital printing system is indicated generally at 10 which includes a first print line indicated generally at 12 which includes a feeder 14, a marking engine 16 and a stacker/finisher 18. A controller 20 is provided which may include the digital front end (DFE) for marking engine 16 and which has a graphical user interface 22 for providing user information and accepting user input commands.

A second print line indicated generally at 22 is juxtaposed to the finisher 18 and includes a feeder 24 adjacent finisher 18, marking engine 26, stacker/finisher 28 and a controller 30 which may also include the digital front end for marking engine 26. The controller 30 also includes a graphical user interface 32 for moving user information and receiving user command input. The controllers 20, 30 have been indicated as including the DFE; however, the DFE may be located in the cabinetry for the respective marking engines 16, 26 if desired.

In the architecture depicted in FIG. 1, it is advantageous that the print lines 12, 22 be of the same variety in order to gain the greatest benefit from the arrangement of having tandem print lines capable of either independent or serial feed printing of cut sheets, particularly for duplex printing and where it is desired to maximize the throughput or print speed of the marking engines.

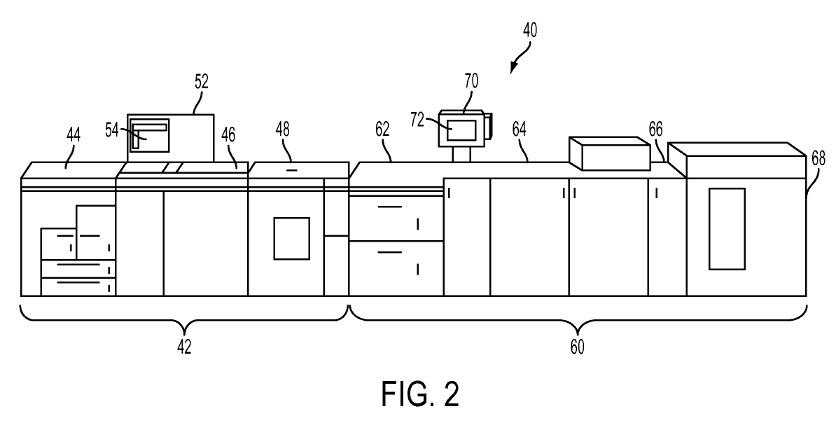

Referring to FIG. 2, another version of the system of the present disclosure is indicated generally at 40 and includes a first print line indicated generally at 42 having a feeder 44, a marking engine 46 which is of the monochromatic printing capability and a finisher 48. A controller 52 is disposed atop the marking engine 46 and may include the digital front end (DFE) for marking engine 46 and has a graphical user interface (GUI) provided thereon as denoted by reference numeral 54.

A second print line indicated generally at 60 is juxtaposed to the finisher 48 of print line 42; and, the print line 60 includes a feeder 62, a multi-colorant marking engine 64, a merge and transport unit 66 and a finishing unit 68. A controller 70 is provided with a graphical user interface 72 provided thereon; and, the controller 70 may include the digital front end (DFE) for the marking engine 66.

In the version 40 of FIG. 2, the print lines 42 and 64 may be operated either independently or in tandem or serial mode wherein sheets from print line 42 are fed directly through marking engine 60 bypassing the feeder 62 where monochrome printing on one side of a sheet and multi-colorant printing on the opposite side is desired. Alternatively, duplex monochromatic printing may be accomplished in the print line 42 by inverting and re-feeding with the sheets subsequently bypassing the marking engine 60 and assembled in the merge and transport unit 66 for feeding to the finisher 68.

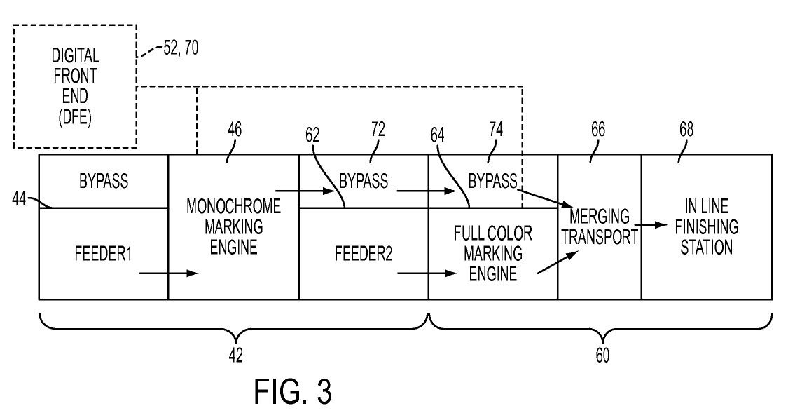

Referring to FIG. 3, the function of the system 40 of FIG. 2 is indicated in block diagram wherein the digital front end (DFE) 52, 70 is operatively connected to the monochrome marking engine 46 and the print line 64. The diagram of FIG. 3 shows the arrangement wherein the system 40 of FIG. 2 is operated in an independent mode wherein sheets from feeder 1 are marked in the monochrome marking engine 46, either in simplex or duplex, and then transported through a by-pass 72 and 74 directly to the merging and transport unit 66 whereupon the monochromatic sheets are merged with sheets marked independently in the multi-colorant marking engine 64 are fed to the final finishing unit 68.

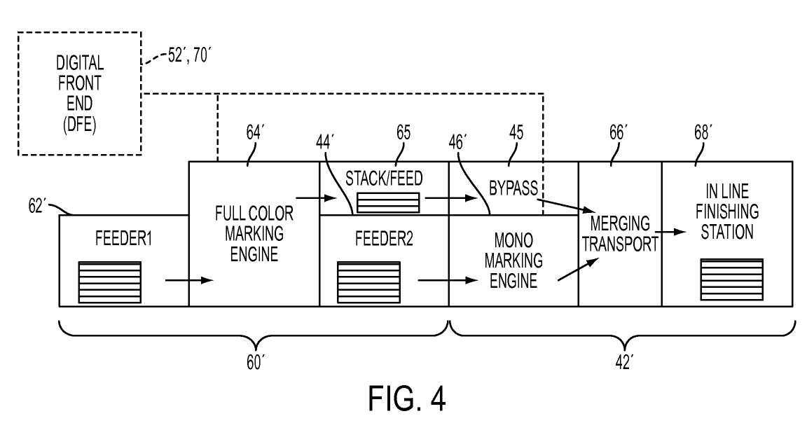

Referring to FIG. 4, the operation of the system of FIG. 2 in tandem or serial feed mode is shown in block diagram wherein the DFE 52′, 70′ is connected to the multi-colorant marking engine which forms a part of a print line indicated generally at 60′; and, the DFE is also connected to a monochromatic marking engine 46′ which forms a part of a second print line indicated generally at 42′. The multi-colorant print line 60′ includes feeder 62′ and a buffer or stack/feed unit 65. A monochromatic print line 42′ includes a feeder 44′, a by-pass transporter 45 and a transport merging unit 66′ and a finishing unit 68′.

The diagram in FIG. 4 thus illustrates operation of the architecture of FIG. 2 wherein the multi-colorant marking engine marks images on sheets from the feeder 62′ and stores them in the buffer 65 until the monochromatic sheets from marking engine 46′ are ready to be merged therewith; whereupon, the sheets are transported from buffer 65 through by-pass transporter 45 to the merging unit 66′, merged with the color image sheets from marking engine 64′ and passed to the finishing unit 68′. The operation as shown in FIG. 4 thus enables a mix of color image sheets to be assembled in a document which may contain primarily monochromatic marked sheets which are typically processed at a higher speed to be assembled in a common finisher.

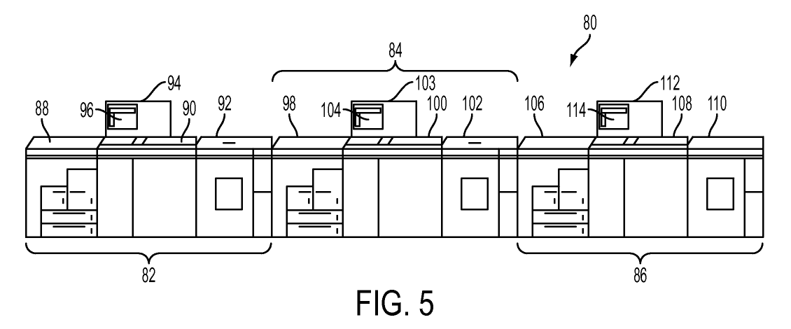

Referring to FIG. 5, another version of the printing system of the present disclosure is indicated generally at 80 and includes three juxtaposed tandem print lines indicated generally at 82, 84, 86 with the print line 82 including a feeder 88, marking engine 90 and a finisher 92 with a controller 94 which may include a digital front end (DFE) and which has a graphical user interface indicated at 96.

Print line 84 includes a feeder 98 disposed adjacent the finisher 92, a marking engine 100 and a finisher 102. The print line 84 also includes a controller 103 which may include the digital front end for the marking engine 100 and the controller has a graphical user interface 104 for providing user information and accepting user command inputs.

The third print line 86 has a feeder 106 disposed adjacent the finisher 102 of print line 84, a marking engine 108 and a finisher 110 with a controller 112 which may contain the DFE for marking engine 108 and a graphical user interface 114. The controllers may be configured such that the graphical user interfaces 96, 104, 114 may be employed to operate the system from any one of the GUIs 96, 104, 114.

The system 80 of FIG. 5 may be operated in several different modes one of which employs the print lines 80, 82, 84 operated as independent print lines each marking sheets from its own feeder respectively and outputting the sheets to respectively its own finishing unit. Alternatively, two of the print lines such as 82, 84 may be operated in tandem mode for duplex printing where the first printer of the tandem pair prints on one side of the sheet and the second printer of the tandem pair prints on the opposite side such that the printers are operating concurrently to provide increased throughput or productivity. In this mode, the remaining third print line 86 operated independently and may even print a different print job. This latter mode of operation is especially useful where a print job requires high speed duplex printing for a multi-paged large document; and, a second print job of fewer pages may be printed simultaneously at a lower rate of productivity.

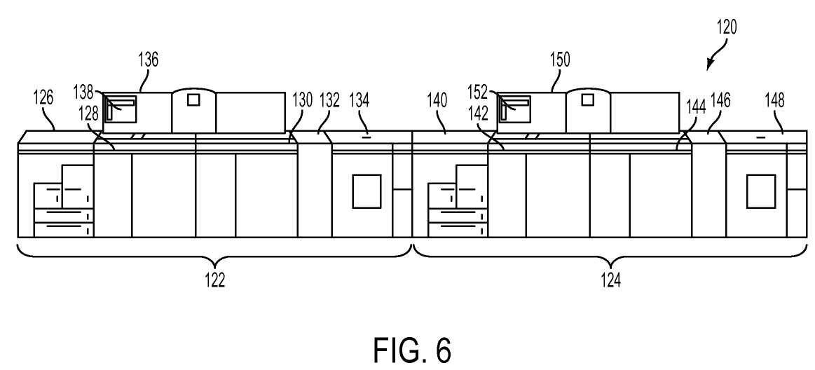

Referring to FIG. 6, another version of the cut sheet printing system of the present disclosure is indicated generally at 120 and includes a double or tandem print line indicated generally at 122 juxtaposed adjacent or in tandem with a second double or tandem print line indicated generally at 124.

The print line 122 includes a feeder 126 for sheet stock which is disposed adjacent a first marking engine 128 which has disposed in tandem and adjacent thereto a second marking engine 130 which is disposed adjacent a merging transporter 132 which has adjacent thereto a finisher 134. The marking engines 128, 130 include a controller 136 which may include the DFEs for both marking engines; and, controller 136 includes a graphical user interface (GUI) 138.

The second print line 124 includes a second sheet feeder 140, a third and fourth tandem marking engines 142, 144, the fourth of which is disposed adjacent a merging transporter 146 which has disposed adjacent thereto a finisher 148. The print line 124 includes a controller 150 which may include the DFE for both marking engines 142, 144 and has a graphical user interface 152 thereon.

The system 120 of FIG. 6 may be operated from either GUI 138, 152 by the user because the controllers 136, 150 are arranged to permit control of all marking engines in the system there from either of the controllers.

The system 120 may be operated in a dual tandem mode where high speed duplex marking of sheets from feeder 126 is accomplished in tandem marking engines 128, 130; and, independently and concurrently therewith duplex marking of sheets from feeder 140 may be accomplished in the tandem marking engines 142, 144 to thus permit high speed duplex printing of two different print jobs simultaneously.

Alternatively, the system of FIG. 6 may be operated in another mode wherein sheets are fed individually to marking engines 128, 130 from the feeder 126 and sheets are fed individually from feeder 140 to marking engines 142, 144. In this latter mode, while a sheet is being marked in marking engine 128, feeder 126 is operative to feed a sheet to an internal by-pass transporter into marking engine 130 for concurrent high speed simplex printing. Accordingly, the same mode of operation may be accomplished in the print line 124.

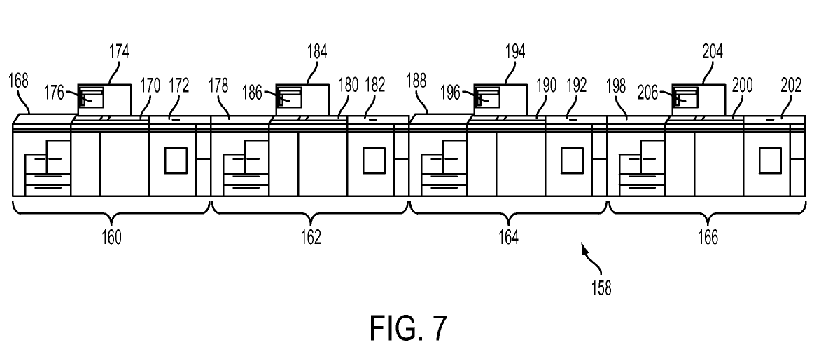

Referring to FIG. 7, four single print lines indicated generally at 160, 162, 164, 166 are disposed adjacent tandem in line arrangement. The print line 160 includes a feeder 168, a marking engine 170 and a finisher 172 with a controller 174 which may include the DFE for the marking engine 170 and a graphical user interface 176 for user information and command input. The second print line 162 also includes a feeder 178, a marking engine 180 and a finisher 182. A controller 184 is provided and may include the DFE for the marking engine 180 and has a graphical user interface 186 for providing information to the user and accepting user input commands. The third print line 164 also has a feeder 188, a marking engine 190 and a finisher 192. A controller 194 is provided and may include the DFE for the marking engine 190 and has a graphical user interface 196 for providing information to the user and accepting user input commands. The fourth print line 166 has a feeder 198 juxtaposed to the finisher 192 and has a marking engine 200, a finisher 202 and a controller 204 which may include the DFE for marking engine 200. The controller 204 has a graphical user interface 206 for providing information to the user and for accepting user input commands.

The system of FIG. 7 denoted generally by reference numeral 158 may be operated as four individual print lines each operating with the same or different print jobs feeding cut sheets from their respective feeders and outputting the sheets to their respective finisher units; and each individual print line may be operated in either a simplex or duplex mode.

Alternatively, the system 158 may be operated with print lines 160, 162 in series or tandem and print lines 164, 166 in series or tandem, enabling high speed printing in the duplex mode where for example, print line 160 would mark one side of the sheet from feeder 168 on one side in marking engine 170 and feed the sheet directly to marking engine 180 by passing the feeder 178 and marking the opposite side of the sheet in marking engine 180 thereby permitting marking engines 170 and 180 to operate concurrently. In similar manner, feeder 188 can feed sheets to marking engine 190 for marking on one side of the sheet whereupon the sheet is transported to by-pass feeder 198 and is fed directly to marking engine 200 for marking on the opposite side thereof. In another mode of operation, the print lines 160, 162 may be operated in tandem and the print lines 164, 166 operated independently.

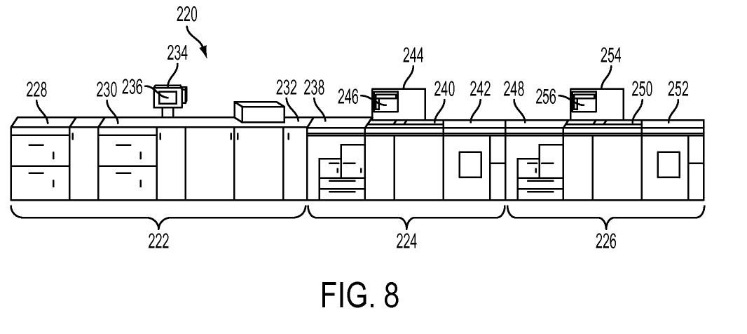

Referring to FIG. 8, another version of the system of the present disclosure is indicated generally at 220 and includes a multi-colorant print line indicated generally at 222, a monochromatic print line indicated generally at 224 disposed adjacent the multi-colorant print line and a second monochromatic print line indicated generally at 226 in tandem with the print line 224. The multi-colorant print line 222 includes a feeder 228, a multi-colorant marking engine 230 and a finisher 232 with a controller 234 which may include the DFE for the marking engine 230 and which includes a graphical user interface 236 for providing information to the user and accepting user input commands.

Monochromatic print line 224 includes a feeder 238, a monochromatic marking engine 240 and a finisher 242 with a controller 244 which may include the DFE for marking engine 240 and which has a graphical user interface 246 for providing information to the user and accepting user input commands.

The second monochromatic print line 226 includes a feeder 248, a marking engine 250, a finisher 252 and a controller 254 which may include the DFE for marking engine 250 and which has a graphical user interface 256 for providing information to the user and accepting user input commands.

In one mode of operation of the system 220, the multi-colorant print line 222 may be operated in tandem with the print line 224 for duplex printing of color on one side of the sheets and monochromatic printing on the opposite side with the third print line 226 operated in dependently.

In another mode of operation, the system may operate print line 222 independently for multi-colorant image printing either in simplex or duplex; and, print lines 224, 226 may be operated in tandem for high speed duplex monochromatic printing with sheets from feeder 228 being marked on one side in marking engine 240 and by-passing finisher 242 and feeder 248 for marking engine 250 on the opposite side thereof to permit high speed concurrent printing in both marking engines 240 and 250.

In another mode of operation, the three print lines 222, 224, 226 may be operated independently to process cut sheets individually from their own respective feeders.

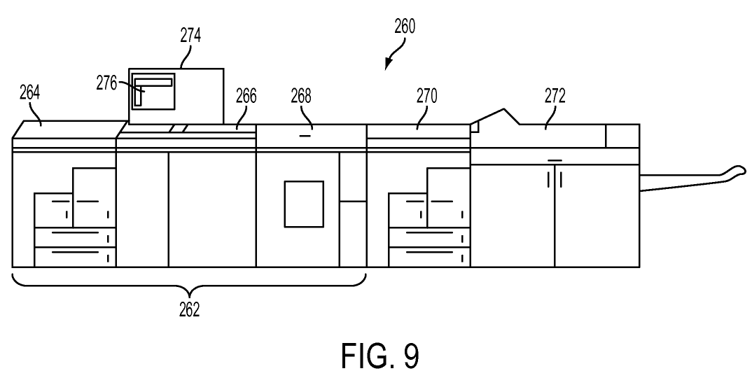

Referring to FIG. 9, another version of the printing system of the present disclosure is indicated generally at 260 and includes a print line indicated generally at 262 which has a feeder 264, a marking engine 266 and a finisher 268. An interposer auxiliary feeder is disposed adjacent the finisher 268 as denoted by reference numeral 270 and a finisher is disposed adjacent the feeder 270 as denoted by reference numeral 272. A controller 274 is provided and may include the DFE for the marking engine 266 and has a graphical user interface 276 which may provide information to the user and accept user input commands.

The system 260 may operate with sheets printed in either simplex or duplex on the print line 262 and fed to the finisher 268; or, sheets having color images marked thereon may be loaded into the interposed auxiliary feeder 270 and fed together with the output of the marking engine 266 into the finisher 272 for document assembly. The customer could print the monochromatic image sheets in print line 262, store them in the interposed auxiliary feeder 270 and continue using the print line 262 and then load sheets marked with colored images into the interposed auxiliary feeder 270 for feeding into the finisher 272.

The present disclosure thus provides a printing system for printing on cut sheet stock in either multi-colorant or monochromatic image modes and either duplex or simplex or with combinations thereof from print lines arranged in tandem for the various combinations of marking. In one version, an interposed auxiliary feeder is provided to enable the user to employ offline finishing while the print line is in operation.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. a digital printing system for cut sheet media stock comprising:
(a) a first and second print line disposed adjacently, each including a sheet feeder, a marking engine and a sheet stacker/finisher;
(b) said first and second print lines being operative to switch between a first and second mode of operation; and,
(c) wherein in the first mode of operation the first and second print lines are each operative to mark independently on sheet media stock from the respective feeder and in the second mode of operation the first and second print lines are operative to mark sequentially on print media sheet stock from only one of the feeders.

2. The system defined in claim 1, wherein in the first mode of operation the first and second joint lines are operative to mark sheets concurrently.

3. The system defined in claim 1, further comprising:
at least one additional print line disposed sequentially adjacently with said first and second print lines; and, wherein two of said first, second and at least one additional print line are operative in the second mode of operation and the remaining print line is operative in the first mode.

4. The system defined in claim 1, wherein the print lines are operative to feed sheets through both first and second working engines and output through a common stacker/finisher.

5. The system defined in claim 4, wherein the sheets are marked by only one of the first and second marking engines.

6. The system defined in claim 1, wherein in the second mode the sheets are transported along a path bypassing one of the first and second marking engines.

7. The system defined in claim 1, further comprising: a third and fourth print line each including a sheet feeder, a marking engine and stacker/finisher and disposed adjacently with said first and second print lines, wherein in the first mode said first, second, third and fourth print lines are operative to mark independently from their respective sheet feeder; and, in the second mode, said first and second print lines are operative to mark sequentially on print media sheet stock from on one of their respective feeders and said third and fourth print lines are also operative to mark sequentially on print media sheet stock from only one of their respective feeders.

8. The system defined in claim 7, wherein said first and second print lines are operative to feed print media sheets to a first common finisher and said third and further print lines are operative to feed print media sheets to a second common finisher.

9. The system defined in claim 7, wherein said first, second, third and fourth print lines are operative to feed print media sheet stock to a common finisher.

10. The system defined in claim 1, wherein one of said first and second print lines has a monochrome marking engine and the other of said first and second print lines has a multi-colorant marking engine.

11. The system defined in claim 10, wherein in the second mode of operation the monochrome marking engine is operative to mark on one side of a sheet of print media and the multi-colorant marking engine is operative to mark on a side opposite the one side of the sheet.

12. The system defined in claim 10, wherein in the second mode of operation only one of the first and second monochromatic and multi-colorant marking engines is operative to mark the print media sheet and the sheet stock by-passes the other of said marking engines.

13. The system defined in claim 10, wherein in the second mode of operation the monochromatic marking engine and the multi-colorant marking engine are operative to mark on a common surface of print media sheets and to feed sheets to a common finisher.

14. The system defined in claim 1, wherein said one of said first and second print lines includes only a feeder and stacker/finisher and in the first mode of operation each of said first and second print lines is operative to feed print media sheet stock from its respective feeder to its respective finisher independently.

15. The system defined in claim 14, wherein in the second mode of operation the one of said first and second print lines including a marking engine is operative to feed print media sheet stock from its respective feeder to the marking engine and sequentially to the finisher of the other of the print lines whereby the feeder of said other of the print lines does not feed sheet stock.

16. A method of digital printing comprising:
(a) providing a first and second print line each including a sheet feeder, a marking engine and a sheet stacker/finisher; and,
(b) switching the first and second print lines between a first mode of operation in which the print lines are operative to mark independently sheets from their respective feeders and a second mode of operation in which the print lines are operative to mark sequentially on print media sheet stock from only one of the feeders.

17. The method defined in claim 16, wherein the step of switching includes the print lines marking concurrently in the first mode.

18. The method defined in claim 16, wherein the step of providing includes providing at least one additional print line disposed sequentially with the first and second print line; and,
the step of switching includes operating two of the print lines in the second mode and operating the remaining print line in the first mode.

19. The method defined in claim 16, wherein the step of switching includes feeding sheets through the first and second marking engines and output through a common stacker/finisher.

20. The method defined in claim 19, wherein the step of switching includes marking sheets with only one of the marking engines.

21. The method defined in claim 16, wherein the step of switching includes transporting sheets in the second mode along a path bypassing one of the first and second marking engines.

22. The method defined in claim 16, wherein the step of providing includes providing a third and fourth print line each including a sheet feeder, a marking engine and a stacker/finisher and disposed adjacent the first and second print lines and in the first mode marking sheets independently from the feeders respectively for the first, second, third and fourth print lines and in the second mode marking sheets sequentially in the first and second print lines from a only one of their respective feeders and marking sheets sequentially in the third and fourth print lines from only one of their respective feeders.

23. The method defined in claim 22, wherein the step of marking includes feeding sheets from the first and second print lines to a first common feeder and feeding sheets from the third and fourth print lines to a second common feeder.

24. The method defined in claim 22, wherein the step of marking includes feeding sheets from the first, second, third and fourth print lines to a common feeder.

25. The method defined in claim 16, wherein the step of providing includes providing one of said first and second print lines with a monochrome marking engine and the other of the print lines with a multi-colorant marking engine.

26. The method defined in claim 25, wherein the step of switching includes marking one side of a sheet in the monochrome marking engine and the opposite side of the sheet in the multi-colorant marking engine.

27. The method defined in claim 25, wherein the step of switching includes in the second mode, marking in the monochromatic marking engine and the multi-colorant marking engine on a common surface of print sheet media and feeding the sheets to a common finisher.

28. The method defined in claim 16, wherein the step of providing includes providing one of the print lines with only a feeder and stacker/finisher and the step of switching includes feeding sheets in the first mode from the respective feeder to the respective finisher independently.

29. The method defined in claim 28, wherein the step of feeding sheet stock from the respective feeder includes in the second mode, feeding sheet stock to the finisher of the other of the print lines and not feeding sheet stock from the feeder of the other of the print lines.
